(19) United States
(12) Patent Application Publication
(10) Pub. No.: US 2007/0262592 A1
(43) Pub. Date: Nov. 15, 2007

(54) Mounting plate for lock and lock therewith

(75) Inventors: Shih-Ming Hwang, Irvine, CA (US); Liang-Lun Hwang, Irvine, CA (US); Chien-Jong Hwang, Irvine, CA (US)

Correspondence Address: BACON & THOMAS, PLLC, 625 SLATERS LANE, FOURTH FLOOR, ALEXANDRIA, VA, 22314, US

(73) Assignee: Shih-Ming Hwang, Irvine, CA (US)

(21) Appl. No.: 11/429,144

(22) Filed: May 8, 2006

(51) Int. Cl. E05C 19/16

(52) U.S. Cl. 292/251.5

(57) ABSTRACT

The present invention relates to a mounting plate for a lock and a electromagnetic lock therewith, wherein a top of a lock body (e.g., a electromagnetic body) of a lock is fixed on a door frame via a mounting plate, the mounting plate comprising a plurality of mounting apertures placed at both ends thereof, and a plurality of mounting holes which an elliptical shape being spaced apart by a predetermined distance, and being provided in a portion between the mounting apertures, and each of the mounting apertures comprising an inner flange formed along an edge thereof wherein the flange of one of the mounting holes is placed opposite the flange of any adjacent one of the mounting holes. In installation, edge of head of each mounting screw on top of lock body is adapted to obliquely insert into the mounting holes and then slide clockwise to rest on the flange. Finally, a plurality of screws are driven through the mounting plate for securing the mounting plate onto the electromagnetic body.

### BACKGROUND OF THE INVENTION

1. Field of the Invention

The present invention relates to mounting plates for electromagnetic locks and more particularly to a mounting plate that facilitates the mounting of an electromagnetic lock on a fixed door frame or door post with a plurality of mounting holes designed to overcome safety issues related to the possibility of the electromagnetic lock falling and accidentally hurting a worker during installation.

2. Description of the Prior Art

The technology employed in the design and building of electromagnetic locks has developed rapidly in the past few decades, resulting in a significant improvement in the quality of such locks. A wide variety of electromagnetic locks are produced by several manufacturers of the art. Such electromagnetic locks are now mass-produced, and are characterized by being structurally strong, durable, power saving, and causing no pollution to the environment. However, little has been done in terms of designing an electromagnetic lock with the aim of helping prevent workplace accidents from the heavy electromagnetic lock body falling and hurting the installer of the device.

A conventional electromagnetic lock is shown in FIG. 1 and comprises an electromagnetic body 10 and a metal armature plate 15. During installation, the electromagnetic body 10 is mounted on a fixed door frame or door post and the metal armature plate 15 is mounted on a moveable door or gate. Further, the metal armature plate 15 is secured to the moveable door or gate in such a position that the metal armature plate 15 and the electromagnetic body 10 can touch each other when the door or gate is closed.

The electromagnetic body 10 typically comprises a plurality of transverse grooves 11 and an electromagnet 12 formed by winding a coil of wire around the grooves of a plurality of silicon steel plates, the electromagnet 12 being mounted alternately in the grooves 11. A frame 13 is fitted with the electromagnetic body 10 with a control circuit 14 therein. The electromagnetic body 10 is electrically connected to a power source via the control circuit 14. Thus, magnetism is produced by the electromagnet 12 in the electromagnetic body 10 when an electric current flows through the wire coil.

Electromagnetic force is produced when electric current flows through the electromagnetic body 10 in response to power being supplied to the control circuit 14. When that power is supplied to the control circuit 14, the resulting magnetism pulls metal armature plate 15 to the electromagnetic body 10. As a result, the door is snugly engaged with the door frame or door post, i.e., the door is locked.

However, the electromagnetic force produced by the electromagnet 12 in the electromagnetic body 10 disappears in response to power being disconnected from the control circuit 14 and the electromagnetic body 10. As a result, the metal armature plate 15 is no longer drawn to the electromagnetic body 10 and the door is unlocked.

The electromagnetic lock further comprises a standard accessory such as a mounting plate 16. The mounting plate 16 is used to mount the electromagnetic body 10 on the door frame or door post. The mounting plate 16 is designed and shaped to fit snugly on one side of the electromagnetic body 10. The mounting plate 16 comprises a plurality of mounting apertures 161 at both ends. A plurality of screws 17 are driven through the mounting apertures 161 into the door frame or door post for fastening the mounting plate 16 to the door post. This is a first step in installing the electromagnetic lock.

Moreover, the mounting plate 16 further comprises a wire opening 162 on one end thereof, with the location of the wire opening 162 correspondingly to the location of the control circuit 14. A cord 141 is extended from the control circuit 14 through the wire opening 162. Two mounting holes 163 are provided in an intermediate portion of the mounting plate 16. The mounting holes 163 are spaced apart by a predetermined distance. Two mounting screws 18 are provided on the top of the electromagnetic body 10 and are projected by a predetermined distance. The mounting screws 18 are adapted to insert into the mounting holes 163 so the electromagnetic body can be slid place in order to secure the electromagnetic body to the door frame or door post. Next, two screws 131 having a hexagonal head embedded in the frame 13 are driven through the mounting plate 16 for securing the electromagnetic body 10 onto the mounting plate 16. Each of the mounting holes 163 are shaped like a gourd and comprises a small portion having an arc edge and a large portion having an arc edge. An inner flange 164 is formed along the arc edge of the small portion of the mounting hole 163. Also, one mounting hole 163 is oriented the same as the other mounting hole 163. Thus, heads 181 of both mounting screws 18 are attached to the flanges 164 of the mounting holes 163 and are supported thereby.

However, the prior electromagnetic lock suffered from several disadvantages. For example, the electromagnetic lock has a relatively heavy weight. Also, high precision is required to mount the electromagnetic body 10 and the metal armature plate 15 relative to each other. Furthermore, the mounting plate 16 and the electromagnetic body 10 are mounted with the mounting plate 16 on top and the electromagnetic body 10 located below. In this installation, a worker drive the screws 17 through the mounting plate 16 into the door frame or door post for fastening. Next, as stated above, the worker insert the mounting screws 18 of the electromagnetic body 10 into the mounting holes 163 and slide the electromagnetic body 10 so that the mounting screws 18 are screws into the mounting holes 163. However, such an installation, procedure has such disadvantageous as a limited installation angle, irregularly-shapes mounting holes 163, and a heavy electromagnetic body 10. Thus, the electromagnetic body 10 is subject to displacement prior to fastening the electromagnetic body 10. As a result, the electromagnetic body 10 may fall and hurt installer worker below.

Thus, the consideration mounting plate 16 is not well suited to the quick and safe installation of electromagnetic bodies 10. Hence, a need has arisen for an improved mounting plate 16 in order to overcome the inadequacies of the prior art.

### SUMMARY OF THE INVENTION

After considerable research and experimentation, a mounting plate for electromagnetic lock that facilitates the mounting of an electromagnetic lock on a fixed door frame or door post with a plurality of mounting holes designed to overcome safety issues according to the present invention has been devised so as to overcome the above drawbacks of the prior art.

It is an object of the present invention to provide a mounting plate for electromagnetic locks that overcome inadequacies including the possibility of the electromagnetic lock being displaced prior to fixing the lock in a permanent position, the difficulty of precisely mounting the electromagnetic lock into that permanent position, and the possibility of the electromagnetic lock of falling and accidentally hurting someone below the lock, including even the installer.

It is another object of the present invention to provide a mounting plate for a lock having the advantages of being easy in install and very safe.

To achieve the above and other advantages, the present invention provides a mounting plate mounted on a top of the electromagnetic body of an electromagnetic lock as way of fixed the electromagnetic body being on a door post. The mounting plate comprises a plurality of mounting apertures at both ends and a plurality of mounting holes in between the mounting apertures, the mounting holes being elliptical in shape and spaced apart by a predetermined distance, and each of the mounting apertures comprising an inner flange formed along an edge thereof wherein the flange of one of the mounting holes is placed opposite the flange of any adjacent mounting holes, By utilizing this mounting plate, the electromagnetic body will be prevented from disengaging from the mounting plate to which is to be fastened should it be accidentally or purposely turned. Otherwise, the electromagnetic body may accidentally fall and hurt a worker working there below. With this design, the edge of each mounting screw head is adapted to obliquely insert into the mounting hole and then slide clockwise to rest on the flange, and finally a plurality of screws are driven through the mounting plate for securing the mounting plate onto the electromagnetic body.

The above and other objects, features and advantages of the present invention will become apparent from the following detailed description taken with the accompanying drawings.

### BRIEF DESCRIPTION OF THE DRAWINGS

FIG. 1 is an exploded view of a conventional electromagnetic lock and a mounting plate therefor;

FIG. 2 is an exploded view of a preferred embodiment of electromagnetic lock and a mounting plate therefor according to the invention;

FIG. 3 is a view of the electromagnetic lock of FIG. 2 being mounted on a door;

FIG. 4 is a top plan view showing the mounting of the mounting screws of the electromagnetic lock with the mounting holes of the mounting plate according to the invention; and

FIG. 5 is a view similar to FIG. 4 showing a final step of mounting the mounting screws of the electromagnetic lock with the mounting holes of the mounting plate.

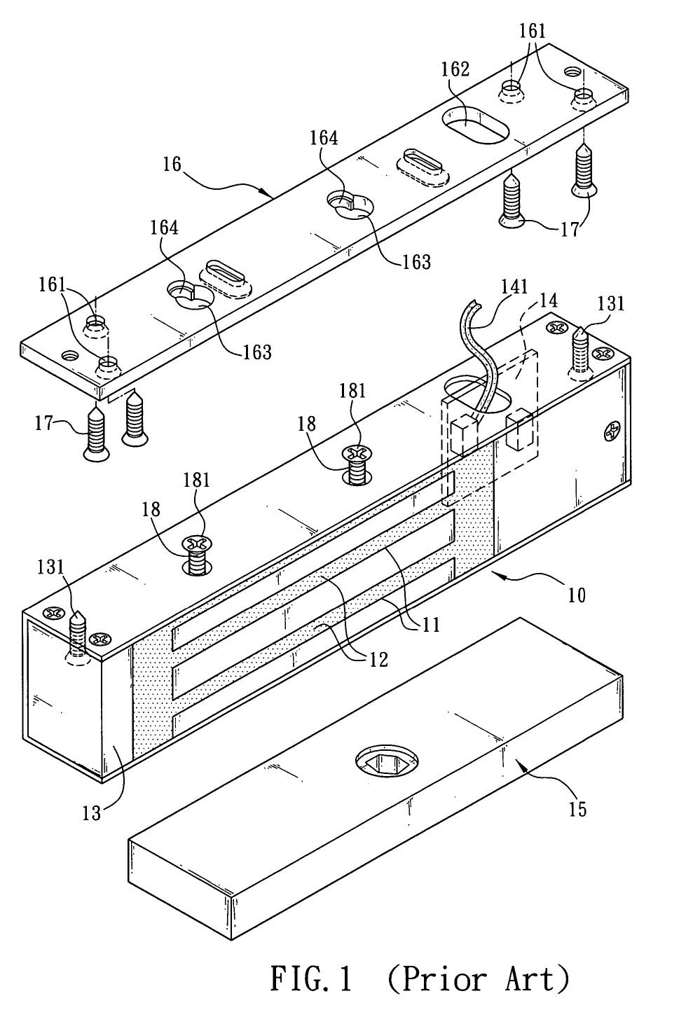

### DETAILED DESCRIPTION OF THE PREFERRED EMBODIMENTS

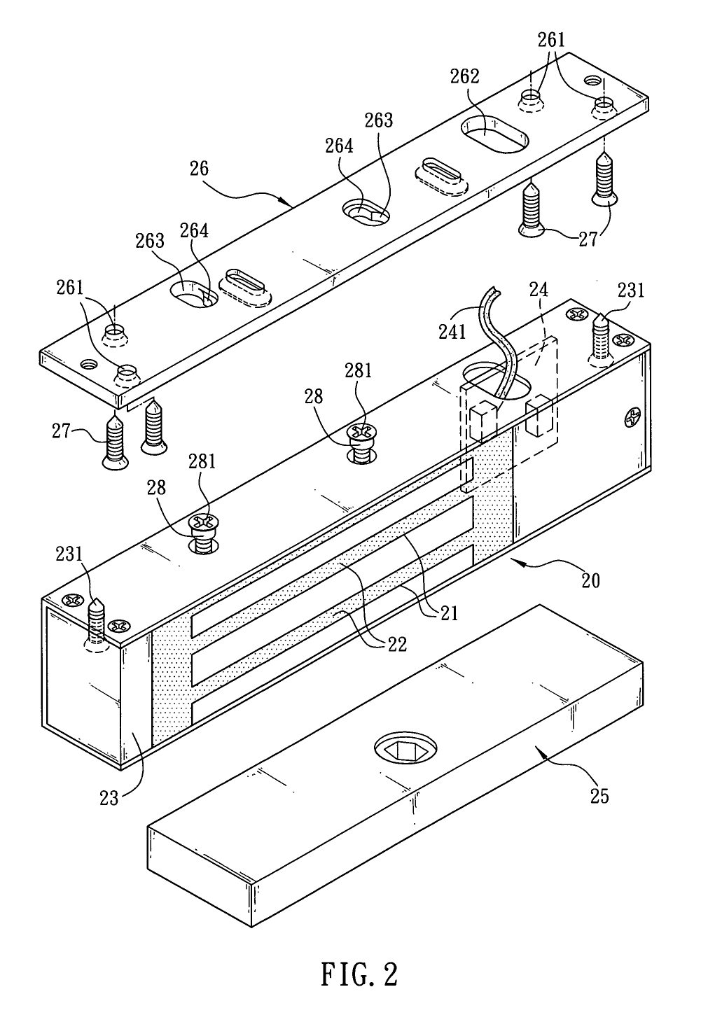

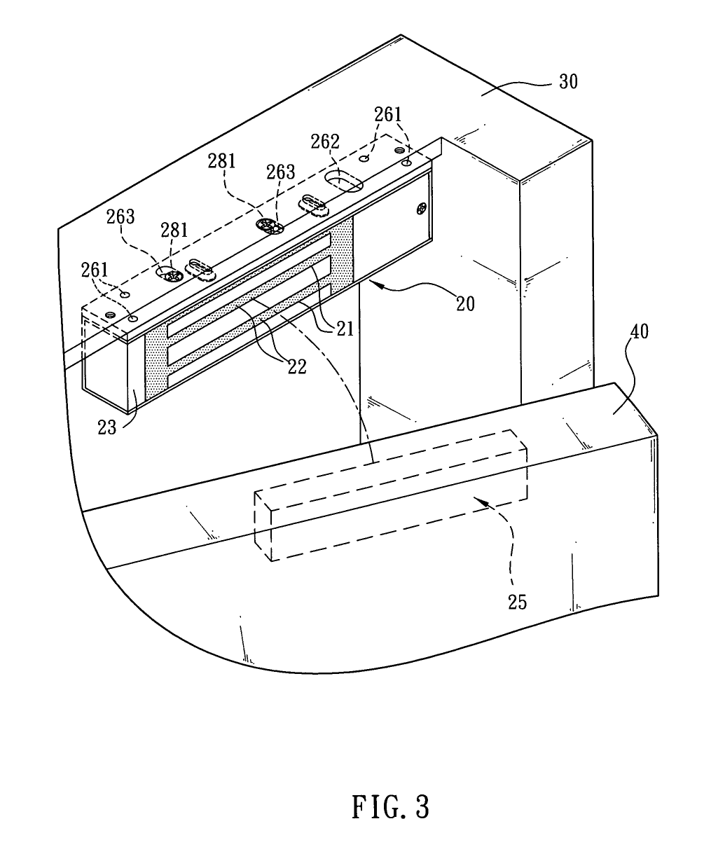

Referring to FIG. 2 and FIG. 3, a mounting plate for electromagnetic locks that facilitates the mounting of an electromagnetic lock on a fixed door frame or door post with a plurality of mounting holes designed to overcome safety issues with a preferred embodiment of the invention is shown. In the preferred embodiment the lock comprises two bodies in which one body is a electromagnetic body 20 and the other one is a metal block 25. When installed, the electromagnetic body 20 is mounted on a fixed door frame or door post 30 and the metal armature plate 25 is mounted on a pivotal or sliding door or gate 40. The metal armature plate 25 is secured to the door frame or gate post 30 in such a position that the metal armature plate 25 and the electromagnetic body 20 can touch each other the door or gate is closed.

The electromagnetic body 20 typically comprises a plurality of transverse grooves 21 and an electromagnet 22 formed by winding a coil of wire around the grooves of a plurality of silicon steel plates, the electromagnet 22 being mounted alternately in the grooves 21. A frame 23 is fitted to the electromagnetic body 20 with a control circuit 24 therein. The electromagnetic body 20 is electrically connected to a power source via the control circuit 24. Thus, magnetism is produced by the electromagnet 22 in the electromagnetic body 10 when an electric current flows through the wire coil.

Electromagnetic force is produced when electric current flows through the electromagnetic body 20 in response to power being supplied to the control circuit 24. When that power is supplied to the control circuit 24, the resulting magnetism pulls metal armature plate 25 to the electromagnetic body 20. As a result, the door is snugly engaged with the door frame or door 30, i.e., the door is locked.

However, the electromagnetic force produced by the electromagnet 22 in the electromagnetic body 20 disappears in response to power being disconnected from the control circuit 24 and the electromagnetic body 20. As a result, the metal armature plate 25 is no longer drawn to the electromagnetic body 20 and the door frame or door post 30, is unlocked.

The electromagnetic lock further comprises a standard accessory such as a mounting plate 26. The mounting plate 26 is used to mount the electromagnetic body 20 on the door frame or door post 30. The mounting plate 26 is designed and shaper to fit snugly on one side of the electromagnetic body 20. The mounting plate 26 comprises a plurality of mounting apertures 261 at both ends. A plurality of screws 27 are driven through the mounting apertures 261 into the door frame or door post 30 for fastening. The mounting plate 26 to the door frame or door post 30. This is the first step in installing the electromagnetic lock.

Moreover, the mounting plate 26 further comprises a wire opening 262 on end thereof, with the wire opening 262 correspondingly to the location of the control circuit 24. A cord 241 is extended from the control circuit 24 through the wire opening 262.

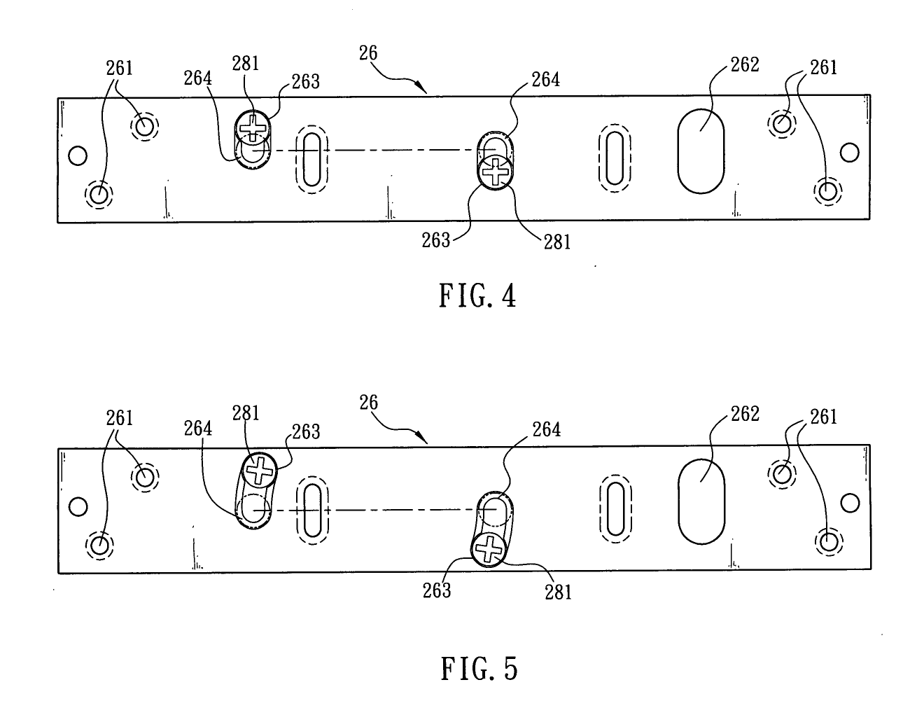

Referring to FIG. 4 in conjunction with FIG. 2, provides further characteristics of the invention. A plurality of mounting holes 263 are provided in a portion between the mounting apertures 261. In the embodiment of the invention, in FIG. 4, the number of the mounting holes 263 is two. The mounting holes 263 are spaced apart by a predetermined distance. A line interconnecting centers of both mounting holes 263 is not aligned with a transverse centerline of the mounting plate 26. Each mounting hole 263 is in the shape of an ellipse. An inner flange 264 is formed along an arc edge of the mounting hole 263. A height difference exists between an opening of the mounting hole 263 and its corresponding flange 264. The position of the flange 264 and the mounting hole 263 are flipped relative to each other for the second flange 264 and second mounting hole 263. A plurality of mounting screws (two are shown) 28 are screwed into the top of the electromagnetic body 20 in such a way that they predetermined distance from the top of the electromagnetic body 20. The edge of head 281 of the mounting screw 28 is adapted to obliquely insert into the mounting hole 263 and then slide clockwise to rest in the flange 264. Finally, two screws 231 having a hexagonal head embedded in the frame 23 are driven through the mounting plate 26 for securing the mounting plate 26 onto the electromagnetic body 20.

Referring to FIG. 5 in conjunction with FIG. 2, the mounting hole 263 has a smooth arc edge of the head 281 of each mounting screw 28 on the top of the electromagnetic body 20 can be moved to secure the electromagnetic body 20 to the mounting plate 26 by turning the electromagnetic body 20 clockwise after insertion.

In view of above, it is clear that a line interconnecting the centers of both mounting holes 263 is not aligned with a transverse centerline of the mounting plate 26 as contemplated by the invention. Also, the position of the flange 264 and the mounting hole 263 are flipped relative to each other for the second flange 264 and second mounting hole 263. The edge of the head 281 of each mounting screw 28 on the top of the electromagnetic body 20 is adapted to obliquely insert into the mounting hole 263, with the electromagnetic body 20 then slide clockwise so that the head 281 rests on the flange 264. In this position, the electromagnetic body 20 is supported temporarily by the flanges 264. This is contrary to the prior art in which the mounting plate and the electromagnetic body are mounted vertically with the mounting plate on top and the electromagnetic body placed underneath. In the final installation step, a worker may drive screws through the mounting plate into the door frame for fastening. The invention has advantages of easy installation and the prevention the electromagnetic body 20 from displaced or falling. Otherwise, a potential hazard may exist. As a result, installation safety is greatly increased.

While the invention herein disclosed has been described by means of specific embodiments, numerous modifications and variations could be made thereto by those skilled in the art without departing from the scope and spirit of the invention set forth in the claims.

1. A mounting plate mounted on a top of a lock body of an electromagnetic lock, the electromagnetic body being fixed on a door frame, comprising:
a plurality of mounting apertures at both ends of said mounting plate; and
a plurality of mounting holes provided in a portion between said mounting apertures, said mounting holes being spaced apart by a predetermined distance, with said mounting holes being in the shape of an ellipse, with each of said mounting holes including an opening having a first portion with no flange and a second portion with an inner flange, the latter of which is formed along an edge of said, mounting holes, wherein the edge of said mounting holes is arc-shaped;
wherein there is a height difference between an opening and said flange, with the relative position of said opening and said flange of one of said mounting holes being the reverse of the position of the second of said opening and said flange of an adjacent said mounting hole.

2. (canceled)

3. The mounting plate of claim 1, wherein a line interconnecting the centers of said mounting holes is not aligned with a transverse centerline of said mounting plate.

4. The mounting plate of claim 1, wherein the lock body is an electromagnetic body.

5. A lock comprising:
a lock body;
a mounting plate mounted on the top of said lock body fixed on a door frame and comprising:
a plurality of mounting apertures at both ends of said mounting plate; and
a plurality of mounting holes provided in a portion between the mounting apertures, said mounting holes being spaced apart by a predetermined distance, with said mounting holes being in the shape of an ellipse, with each of said mounting holes including an opening having a first portion with no flange and a second portion with an inner flange, the latter of which is formed along an edge of said mounting holes, wherein the edge of said mounting holes is arc-shaped;
wherein there is a height difference between said opening and said flange, with the relative position of said opening and said flange of one of said mounting holes being the reverse of position of the second of said opening and said flange of an adjacent said mounting holes; and an armature member mounted on a pivotal door board, the position of said armature member mounted on said pivotal door board correspondingly to the position of said lock body when said pivotal door board is pivoted so that it is next to said door frame.

6. (canceled)

7. The mounting plate of claim 5, wherein a line interconnecting the centers of said mounting holes is not aligned with a transverse centerline of said mounting plate.

8. The lock of claim 5, wherein said lock body is a electromagnetic body and comprises an electromagnet formed therein, and further comprising a control circuit and a frame fitted with said electromagnetic body and said control circuit therein, wherein said control circuit is electrically connected to said electromagnetic body.

9. The lock of claim 8, wherein said mounting plate further comprises a wire opening proximate to one end, said wire opening being placed corresponding to said control circuit, wherein said control circuit comprises a cord extended through said wire opening, and wherein a plurality of mounting screws are fixed on the top of said electromagnetic body and are projected by a predetermined distance, and wherein an edge of a head of each of said mounting screws is adapted to insert into said mounting holes and then slide clockwise to rest on the flange.

10. The lock of claim 5, wherein said armature member is a metal plate.
